(19) United States
(12) Patent Application Publication
(10) Pub. No.: US 2025/0068399 A1
(43) Pub. Date: Feb. 27, 2025

(54) UTILIZING MACHINE LEARNING TO GENERATE AN APPLICATION PROGRAM

(71) Applicant: H2O.ai Inc., Mountain View, CA (US)

(72) Inventors: Shivam Bansal, Bedok South Ave 3 (SG); Piraveen Sivakumar, Jaffna (LK); SriSatish Ambati, Palo Alto, CA (US)

(21) Appl. No.: 18/790,393

(22) Filed: Jul. 31, 2024

Related U.S. Application Data
(60) Provisional application No. 63/534,545, filed on Aug. 24, 2023.

(51) Int. Cl. G06F 8/35; G06F 8/10; G06F 8/38

(52) U.S. Cl. CPC G06F 8/35; G06F 8/10; G06F 8/38

(57) ABSTRACT

An input specifying a schematic of user interface components of an application program is received. A first group of one or more machine learning models is used to automatically identify the user interface components and associated properties specified in the input. Based on the identified user interface components and the associated properties, a second group of one or more machine learning models is used to automatically generate program code implementing the application program including the user interface components.

### CROSS REFERENCE TO OTHER APPLICATIONS

This application claims priority to U.S. Provisional Patent Application No. 63/534,545 entitled CONVERTING WIREFRAMES AND SKETCH DESIGNS TO A FULLY FUNCTIONAL WEB APPLICATION filed Aug. 24, 2023 which is incorporated herein by reference for all purposes.

### BACKGROUND OF THE INVENTION

Web applications have transformed the digital landscape, offering dynamic and personalized user experiences through the Internet. Unlike traditional websites, web applications enable two-way interactions, allowing data exchange with the server and empowering users to engage with server-stored information. From simple message boards to complex e-commerce platforms, web applications have demonstrated their versatility and crucial role in the modern digital era.

### BRIEF DESCRIPTION OF THE DRAWINGS

Various embodiments of the invention are disclosed in the following detailed description and the accompanying drawings.

FIG. 1 is a block diagram illustrating a system to generate an application program in accordance with some embodiments.

FIG. 2 is a block diagram illustrating a pipeline to generate an application program in accordance with some embodiments.

FIG. 3 is a flow diagram illustrating a process to generate an application program in accordance with some embodiments.

FIG. 4A is a block diagram illustrating an example of an input in accordance with some embodiments.

FIG. 4B is an example of an application program generated based on an input in accordance with some embodiments.

FIG. 5A is a block diagram illustrating an example of an input in accordance with some embodiments.

FIG. 5B is an example of an application program generated based on an input in accordance with some embodiments.

FIG. 6A is a block diagram illustrating an example of an input in accordance with some embodiments.

FIG. 6B is an example of an application program generated based on an input in accordance with some embodiments.

FIG. 7A is a block diagram illustrating an example of an input in accordance with some embodiments.

FIG. 7B is an example of an application program generated based on an input in accordance with some embodiments.

FIG. 8 is an example of source code generated for an application program in accordance with some embodiments.

FIG. 9 is an example of an input in accordance with some embodiments.

FIG. 10 is an example of a user interface from which an input is selected in accordance with some embodiments.

FIG. 11 is an example of a graphical user interface in which an input is provided in accordance with some embodiments.

FIG. 12 is an example of a user interface in which an input is provided in accordance with some embodiments.

FIG. 13 is an example of a user interface in which a large language model is used to generate insights into the data associated with an application program.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A technique to generate an application program (e.g., a web application) is disclosed herein. In some embodiments, the application program is configured to run in a web browser. In some embodiments, the application is configured to run on an electronic device, such as a computer, smartphone, tablet, etc. The technique includes receiving an input from a client device. The input specifies a schematic of user interface (UI) components of the application program. The input may be an image file that includes a wireframe or sketch design (e.g., .png, .jpg, .jpeg, .tiff, etc.), a prompt, a data file (e.g., JSON file, CSV file), or a document (e.g., text file, word document, etc.). The client device may be a server, a computer, a laptop, a desktop, a tablet, a smartphone, or any other electronic communication device.

A first group of a plurality of models is used to extract information from the input to automatically identify the user interface components for an application program and properties associated with elements in the input. The plurality of models extracts information (properties), such as counts, dimensions, width, height, x-y placement, center coordinates, labels, etc., from the input. In some embodiments, some or all of the plurality of models in the first group sequentially extract information from that input, that is, a second model extracts information from the input after a first model extracts information from the input. The second model may utilize an output from the first model when extracting information from the input. In some embodiments, some or all of the plurality of models in the first group, in parallel, extract information from that input.

A model of the plurality of models may be a machine learning model, a heuristic model, a statistical model, or any other mathematical model. The machine learning model may be a computer vision model, a natural language processing model, a pre-trained box detection model, a pre-trained text extraction model, an image manipulation model for identifying x-y coordinates of the extracted boxes, and/or a combination thereof. In some embodiments, the first group includes a single model that performs the functions of a plurality of models.

Each of the one or more models output one or more key-value pairs. For example, an optical character recognition model is configured to output a coordinate at which text was written. The key-value pair may also indicate whether the text was included in a box, a header, or a footer.

An object-detection model is configured to detect the number of boxes or other shapes in the input and the corresponding coordinates associated with the detected boxes or other shapes. The object-detection model may be configured to determine the width and height associated with a detected box or other shape, the boundary coordinates associated with the detected box or other shape, and a center coordinate associated with the detected box or other shape. The detected box or other shapes corresponds to a user interface component associated with the application program to be generated.

The plurality of models in the first group of models analyze the input from a different perspective and the key-value pairs outputted from the plurality of models are provided to a second group of one or more models. A model of the plurality of models in the second group may be a machine learning model, a heuristic model, a statistical model, or any other mathematical model.

The key-value pairs provided from the plurality of models in the first group are combined by the second group of one or more models to generate an intermediate vector, which is also referred to as a domain specific language (DSL) token. A DSL token refers to the individual units or elements that make up a DSL. The tokens in a DSL are the building blocks of the language and represent the smallest meaningful units. These tokens can include keywords, identifiers, literals, operators, punctuation marks, and other language-specific symbols. Each token has its own syntactic and semantic meaning within the DSL. In some embodiments, a single model is configured to analyze the input from different perspectives and generate the intermediate vector and DSL token that includes the key-value pairs that would have been generated by the plurality of models. The intermediate vector and DSL token encapsulates the crucial information needed for creating the application program in a particular DSL.

The DSL token is compiled into a respective language code for the application program. The DSL may be utilized for a user-selected framework, such as Django, Streamlit, Flask, Gradio, etc. The code may be stored in a string format for easy manipulation and storage. An application program is generated using the generated code. The application program includes some or all of the user interface components specified in the input.

The application program may be generated for a plurality of different industries, such as predictive maintenance, agriculture, construction, consumer goods, education, energy, financial services, food and beverage, healthcare, information technology, insurance, manufacturing, media, pharmaceuticals, retail, telecommunications, etc. The appearance of the application program may differ based on a selected industry, that is, the application program for a first industry may have a different appearance than the application program for a second industry. In some embodiments, the application program is generated using sample data. In some embodiments, the sample data is for a particular industry. For example, an application program for the construction industry is generated using sample construction data. In some embodiments, the application program is generated using actual data, that is, a user may have provided input data that will be used by the application program.

By interpreting an input, such as a hand-drawn sketch and converting it into a functional application program, the disclosed technique provides an innovative and intuitive path toward software design that significantly improves the efficiency of the development process. This framework offers notable advantages to both novice and expert developers, notably in terms of reducing the technical overhead involved in prototyping, thereby enabling a more streamlined creation process. Furthermore, by offering an easy way to transform abstract design ideas into tangible digital outputs, the disclosed technique paves the way for more diverse and creative applications to emerge. The utilization of application program frameworks within this system is another key highlight, allowing Python developers, such as Python developers, to create real-time, interactive application programs with relative ease. The reactive programming model and its comprehensive library of UI components make the creation of diverse and engaging applications possible.

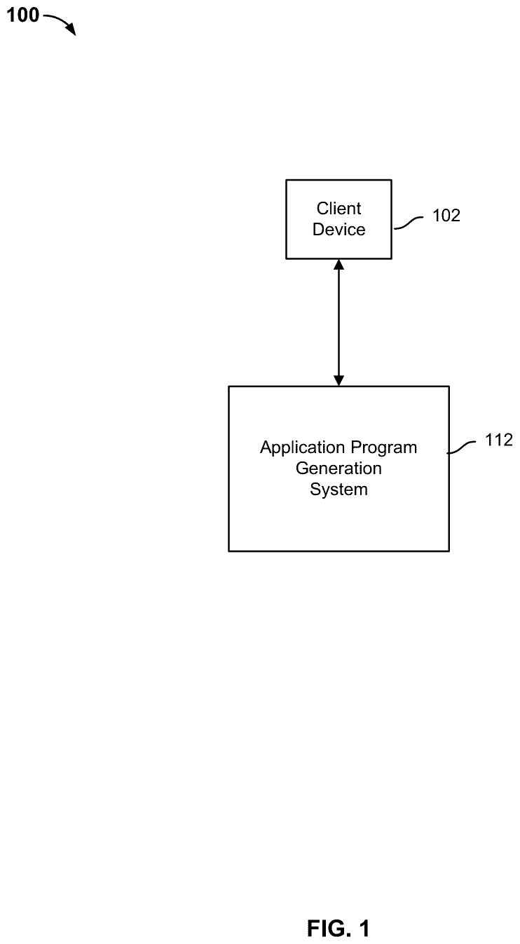

FIG. 1 is a block diagram illustrating a system to generate an application program in accordance with some embodiments. In the example shown, system 100 includes a client device 102 and an app generation system 112. Client device 102 may be a computer, a server, a laptop, a desktop, a tablet, a smartphone, or any other device capable of providing an input, such as an image file, a prompt, a data file, a document, etc. The input describes, illustrates, or conveys the UI components for the application program. Application program generation system 112 is configured to receive the input from client device 102 and generate an application program based on the input. The application program includes some or all of the UI components included in the input. App generation system may be comprised of one or more servers, one or more computers, one or more virtual machines running on one or more computers, and/or one or more containers running on one or more computers.

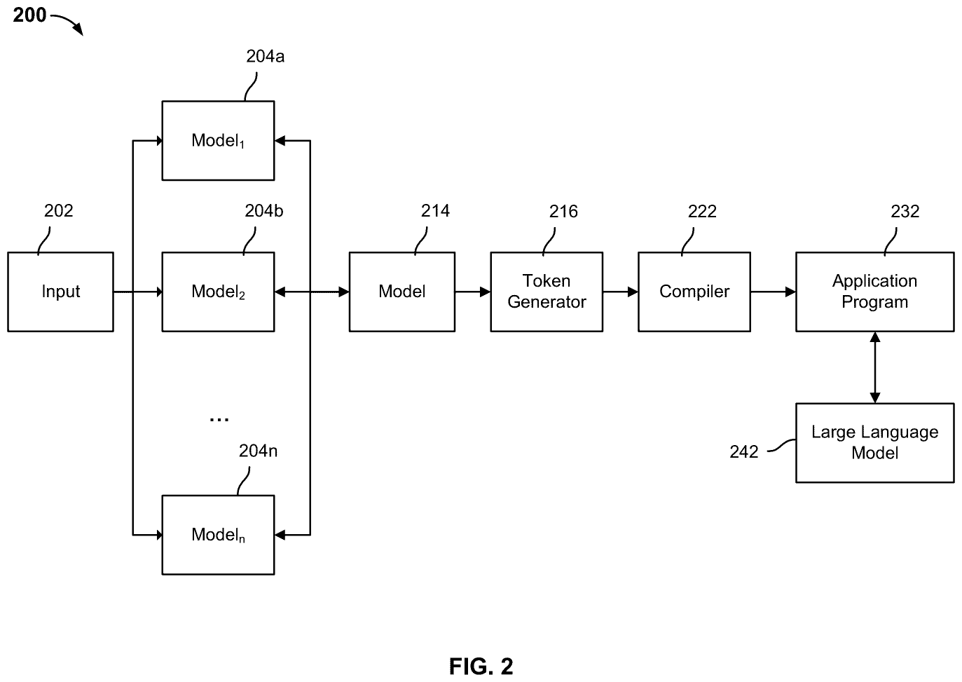

FIG. 2 is a block diagram illustrating a pipeline to generate an application program in accordance with some embodiments. Pipeline 200 may be implemented by an application program generation system, such as app generation system 112. In the example shown, pipeline 200 includes an input 202 received from a client device, such as client device 102. Input 202 specifies a schematic of user interface components of an application program.

Input 202 may be an image file, a prompt, a data file, a document, etc. For an image file, the input may be in different file formats, such as .png, .jpg, .jpeg, or .tiff. The image file includes a sketch or wireframe design that depicts the UI of an application program.

The wireframes include an arrangement of rectangles or “cards,” (and/or other shapes) each embodying a part of the overall layout associated with the application program. These cards may be labeled to signify the type of card required, and their dimensions (width and height) reflect the size of the corresponding cards within the actual application. The placement of these cards, determined by their corresponding x-y coordinates, indicates their final positioning in the generated application program.

An app generation system may provide a UI in which a user may provide a prompt to generate the UI of the application program. The app generation system may include a large language model configured to understand the user prompt to create the UI components of the application program. In some embodiments, the UI of the application program allows the user to modify, via a prompt, the UI components of the application program after the application program is generated. For example, the prompt may include an instruction to widen or shorten one or more UI components of the application program.

An app generation system may provide a user interface in which a user may provide a data file (e.g., CSV file) that includes the data to be depicted in some or all of the user interface components of the application program. In some embodiments, an image file or other type of input is utilized to generate the user interface components of the application program and a data file is provided to populate the UI components with production data (e.g., real-world data) instead of sample data.

An app generation system may provide a user interface in which a user may provide a document that describes the application to be generated. The app generation system may include a natural language processor to understand the text included in the document and generate the application program based on an output of the natural language processor. In some embodiments, the document includes baseline code from which the application program is generated. The user interface may provide a user interface prompt in which the user describes how the baseline code is to be modified.

Input 202 is provided to models 204a, 204b, . . . , 204n. In some embodiments, input 202 is provided, in parallel, to models 204a, 204b, . . . , 204n. In some embodiments, input 202 is provided sequentially to some or all of models 204a, 204b, . . . , 204n. For example, input 202 is initially provided to model 204a, the output of model 204a and input 202 is provided to model 204b, . . . , the output of model 204n-1 and input 202 is provided to model 204n. Although FIG. 2 depicts input 202 being provided to three models, input 202 may be provided to 1:n models. A model may be a machine learning model, a heuristic model, a statistical model, or any other type of mathematical model. A machine learning model may be trained using supervised learning, unsupervised learning, semi-supervised learning, and/or reinforcement learning. In some embodiments, one or more machine learning models are trained using deep learning. A machine learning model may be trained on various images and/or various data sets. In some embodiments, a machine learning model is a fine-tuned version of a pre-trained model configured to detect objects. The pre-trained model is fine-tuned to detect particular shapes (e.g., boxes) in a particular type of image (e.g., wire sketches).

Models 204a, 204b, . . . , 204n may include an image processing model configured to remove noise from an image.

Models 204a, 204b, . . . , 204n may include an object detection model configured to identify various rectangular components or other shapes in input 202, such as plot or text cards. The object detection model may load the image using a computer vision library, such as “OpenCV”, convert the image into a grayscale version of the image to simplify the data, and apply an edge detection algorithm, such as “Canny Edge.” The object detection model identifies the edges of shapes and their contours may be found using a method, such as the ‘findCountours’ method, which also helps to establish the relationships between different contours. For example, the object detection model may detect all rectangles in an image by loading it, identifying shape edges, and discovering their contours.

Models 204a, 204b, . . . , 204n may include a nested object detection model configured to identify and handle nested objects (e.g., boxes or other shapes), indicative of layered UI structures like dropdown menus or dialog boxes. The nested object detection model performs its function after one or more boxes or other shapes are detected by the object detection model. The nested object detection model is configured to check the contour hierarchy from previous steps, determining if any of the detected boxes or other shapes are nested within others. If a nested box or other shape is detected, the nested box or other shape is extracted, processed, and its bounding rectangle is drawn on the image. The nested object detection model employs recursion to manage multiple nesting layers. In some embodiments, the nested object detection model determines that a nested box or other shape is also a parent and repeats the above process to find any further nested boxes or other shapes. After processing a contour and its nested boxes or other shapes, the nested object detection model proceeds to a next contour on the same hierarchical level. The nested object detection model adds the coordinates and dimensions to each detected box to a ‘boxes’ list, creating a real-time comprehensive collection of all identified box-like structures, including the nested ones.

Models 204a, 204b, . . . , 204n may include a filter model configured to filter out one or more shapes (e.g., a box) from an image. Not every detected shape (box) is relevant to the application structure as some may represent noise or insignificant sketch details. For example, a box corresponding to a bar graph may include one or more rectangles. The one or more rectangles included in the bar graph may be filtered out. These boxes are filtered out, while sketch lines indicating separators or sections are converted into box-like forms for uniformity in processing. The filter model is configured to remove a box based on its width and height, for example, discarding a box with dimensions below a certain threshold (e.g., a threshold width or a threshold height). In some embodiments, the filter model is configured to filter out line-like boxes, those with one dimension significantly smaller than the other, retaining only boxes with both dimensions exceeding a specific threshold (e.g., threshold width, threshold length, threshold height). In some embodiments, the filter model is configured to eliminate repetitive boxes to remove redundancy, ensuring each box in the output is unique. The filter model may identify nearly identical boxes as boxes having a center coordinate difference that is below a set threshold. These nearly identical boxes likely represent the same sketch element, but appear as separate boxes due to detection variations. These identified boxes are added to a diction of almost identical shapes.

In some embodiments, the input image includes similar or duplicate boxes or other shapes due to minor variations or noise. An algorithm identifies these boxes or other shapes using their characteristics and location, and these duplicates are then omitted from further processing to increase efficiency. The filter model removes duplicate boxes from the list, relying on the duplicates dictionary previously generated. By checking each box or other shape against the keys in the dictionary, it determines whether a box is a duplicate and excludes it from a final list. Unique boxes and other shapes are included in the output. This ensures the final list is free from duplicates, enhancing subsequent process efficiency and accuracy.

Models 204a, 204b, . . . , 204n may include a conversion model configured to redefine a box or other shape. For example, the box or other shape may be represented by its center coordinates and dimensions instead of top-left corner coordinates, width, and height, which aids further processing.

Models 204a, 204b, . . . , 204n may include a text extraction model configured to extract textual information within each detected object. The textual information may include labels, button names, or other information. The textual information is used to identify the function associated with an object and the associated code that needs to be generated. The app generation system may include a library of functions. The text extraction model is configured to determine which function to select from the library of functions based on the identified function. In some embodiments, a large language model is utilized to generate code for a function that is not included in the library of functions. In some embodiments, the text extraction model is configured to extract the textual information using optical character recognition (OCR). In some embodiments, OCR is used to determine that a detected object is a header. In some embodiments, OCR is used to determine that a detected object is a footer. In some embodiments, OCR is used to determine that a detected object corresponds to a UI component. In some embodiments, the text extraction model is configured to extract the textual information using intelligent character recognition (ICR). The text extraction model is configured to open the image using a library of computer vision functions (e.g., OpenCV) and determine the corresponding area for each detected object. In some embodiments, OCR is used to extract the text from the cropped image portions, initially employing an OCR engine, such as Tesseract OCR engine, and a secondary OCR tool if necessary.

The extracted text is stored in a dictionary (with box or shape parameters as keys and associated text as values) and a list of tuples (containing box or shape parameters and related text). These tuples may be sorted based on vertical and horizontal positions, ensuring logical reading order. In summary, the text extraction model processes each object, extracts related text using OCR or ICR, and organizes this information for case of access and manipulation in subsequent step(s).

The output of models 204a, 204b, . . . , 204n is provided to model 214. Model 214 is configured to establish horizontal and vertical zones with the wireframe or sketch design based on the positions of objects and their corresponding text, aiding understanding of the application's layout and structure.

Model 214 is configured to calculate each non-filtered object vertical span or range of y-coordinates. Model 214 is configured to merge overlapping ranges, sorting them based on their lower limit to create non-overlapping horizontal ‘zones.” Model 214 is configured to group non-filtered objects into their respective horizontal zones based on these ranges. Model 214 is configured to compute each non-filtered object's horizontal span, or range of x-coordinates, within the horizontal zones. Model 214 is configured to merge these horizontal ranges, similar to the vertical ranges, to create non-overlapping vertical ‘zones” within each horizontal zone. Model 214 is configured to group the non-filtered objects into their respective vertical zones based on these ranges.

The final output of model 214 is a two-dimensional grid-like structure that logically organizes the non-filtered objects, following a typical reading order. This facilitates correct information interpretation extracted from the image. The established zones are converted into a more accessible structure, such as a dictionary. Each vertical zone may become a key mapping to another dictionary or list based on its content, providing an efficient data access method. Model 214 is configured to sort this dictionary, ensuring zones and ranges maintain the correct reading order. The dictionary keys, generated to preserve the original order, are sorted to keep zones and ranges in their original sequence. Finally, a string representation of these zones is created, serving as a template for the application's structure in the final Python code.

Token generator 216 is configured to generate one or more tokens that encapsulates a range of information generated by models 204a, 204b, . . . , 204n and model 214. For example, a token may include information extracted by one or more models, such as counts (number of boxes and/or other shapes), dimensions, sizes, and locations. The token may include label(s) based on text extracted from the input to signify the purpose or content of each box or shape. Lastly, the zone identification performed by model 214 discerns the overarching layout of the wireframe or sketch design. The token is a vector that is comprised of key-value pairs. For example, the token may have the form of {x, y, w, h, zone, label}. A wireframe or sketch design corresponds to a unique set of DSL entries, which serve as an intermediary language between the sketch and the final application program code. In essence, these DSL entries form the bridge that translates wireframe sketches and sketch designs into fully functional application programs.

Compiler 222 is used to translate the tokens associated with the detected shapes into code, such as python code. This code will form the bases of application program 232. The code is stored in a string format for easy manipulation and storage.

When executed by a processor, the code enables users to create an interactive application program 232. Application program 232 includes some or all of the user interface components specified in input 202. In some embodiments, large language model 242 is configured to interact with application program 232. In some embodiments, large language model 242 is configured to generate insights (e.g., statistical views, continuous variables, histograms, mean, median, modes, etc.) associated with the data used by application program 232. In some embodiments, LLM 242 is configured to modify the code for application program 232 based on the generated insights. For example, the initial code for application program 232 did not include a user interface component to display the mean associated with a particular variable. After the insights are generated, LLM 242 may update the code for application program 232 such that it includes a user interface component to display the mean associated with the particular variable.

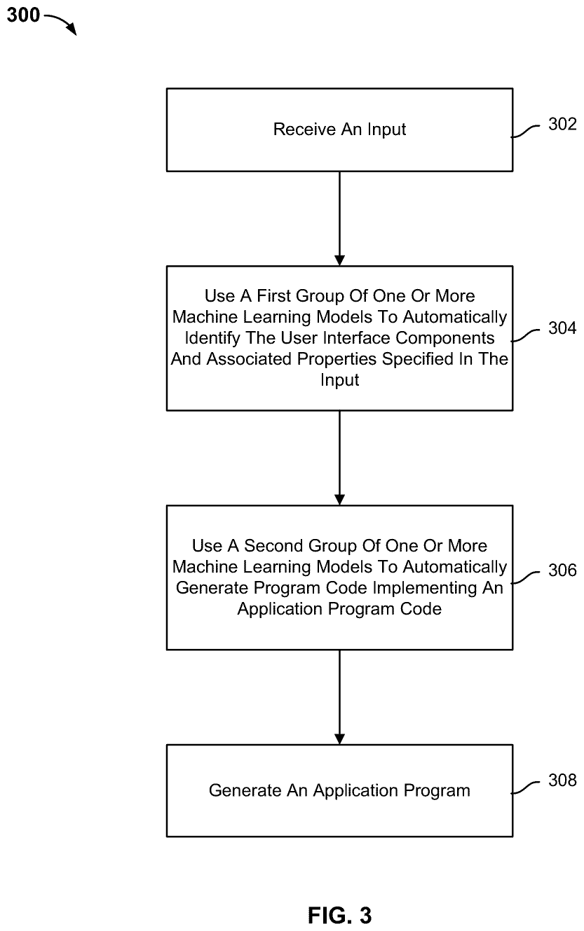

FIG. 3 is a flow diagram illustrating a process to generate an application program in accordance with some embodiments. In the example shown, process 300 may be implemented by an application program system, such as application program system 112.

At 302, an input is received. The input may be an image file, a prompt, a data file, a document, etc.

At 304, a first group of one or more machine learning models are used to automatically identify user interface components and associated properties specified in the input. The first group may include an image processing model configured to remove noise from an image that is provided at the input. The one or more machine learning models may include an object detection model configured to identify various rectangular components or other shapes in the input. The object-detection model is configured to detect the number of boxes or other shapes in the input and the corresponding coordinates associated with the detected boxes or other shapes. The object-detection model may be configured to determine the width and height associated with a detected box or other shape, the boundary coordinates associated with the detected box or other shape, and a center coordinate associated with the detected box or other shape.

The first group of one or more machine learning models may include a nested object detection model configured to identify and handle nested objects (e.g., boxes and/or other shapes), indicative of layered UI structures like dropdown menus or dialog boxes. The nested object detection model is configured to check the contour hierarchy from previous steps, determining if any of the detected objects are nested within others. If a nested object is detected, the nested object is extracted, processed, and its bounding rectangle is drawn on the image.

The first group of one or more machine learning models may include a filter model configured to filter out one or more shapes (e.g., a box) from an image. For example, a box corresponding to a bar graph may include one or more rectangles. The one or more rectangles included in the bar graph may be filtered out. In some embodiments, the filter model is configured to eliminate repetitive boxes to remove redundancy, ensuring each box in the output is unique. The filter model may identify nearly identical boxes as boxes having a center coordinate difference that is below a set threshold. In some embodiments, the input image includes similar or duplicate boxes due to minor variations or noise. An algorithm identifies these boxes or other shapes using their characteristics and location, and these duplicates are then omitted from further processing to increase efficiency. The filter model removes duplicate boxes from the list, relying on the duplicates dictionary previously generated. By checking each box or other shape against the keys in the dictionary, it determines whether a box is a duplicate and excludes it from a final list. Unique boxes and other shapes are included in the output. This ensures the final list is free from duplicates, enhancing subsequent process efficiency and accuracy.

The first group of one or more machine learning models may include a conversion model configured to redefine a box or other shape. For example, the box or other shape may be represented by its center coordinates and dimensions instead of top-left corner coordinates, width, and height, which aids further processing.

The first group of one or more machine learning models may include a text extraction model configured to extract textual information within each detected box or other shape. The textual information may include labels, button names, or other information. The textual information is used to identify the function associated with a box or other shape and the associated code that needs to be generated. The app generation system may include a library of functions. The text extraction model is configured to determine which function to select from the library of functions based on the identified function.

In some embodiments, the image processing model, the object detection model, the nested object detection model, the filter model, the conversion models, and the text extraction model are separate models. In some embodiments, the image processing model, the object detection model, the nested object detection model, the filter model, the conversion models, and the text extraction model are combined into a single model.

At 306, a second group of one or more machine learning models are used to automatically generate program code implementing an application program code. The second group of one or more machine learning models may include a model to calculate each box or other shape's vertical span or range of y-coordinates. The model is configured to merge overlapping ranges, sorting them based on their lower limit to create non-overlapping horizontal “zones.” The model is configured to group boxes or other shapes into their respective horizontal zones based on these ranges. The model is configured to compute each box or other shape's horizontal span, or range of x-coordinates, within the horizontal zones. The model is configured to merge these horizontal ranges, similar to the vertical ranges, to create non-overlapping vertical ‘zones” within each horizontal zone. The model is configured to group the boxes or other shapes into their respective vertical zones based on these ranges. The final output of the model is a two-dimensional grid-like structure that logically organizes the boxes or other shapes, following a typical reading order. In some embodiments, the above functions are performed by a single machine learning model. In some embodiments, the above functions are performed by a plurality of machine learning models.

At 308, an application program is generated. The application program includes some or all of the user interface components specified in the input.

A token generator is configured to generate one or more tokens that encapsulate a range of information generated by the one or more machine learning models in the first group and the one or more machine learning models in the second group. For example, the token may include information extracted by one or more models, such as counts (number of shapes), dimensions, sizes, and locations. The token may include label(s) based on text extracted from the input to signify the purpose or content of each box or shape. Lastly, the zone identification performed by model 214 discerns the overarching layout of the wireframe or sketch design. The token is a vector that is comprised of key-value pairs. The tokens are mapped in an intermediate vector representation of a DSL token. For example, the token may have the form of {x, y, w, h, zone, label}. The DSL token refers to the individual units or elements that make up a DSL. The tokens in a DSL are the building blocks of the language and represent the smallest meaningful units. These tokens can include keywords, identifiers, literals, operators, punctuation marks, and other language-specific symbols. That is, the form of a token is specific to the DSL and each token has its own syntactic and semantic meaning within the DSL.

A wireframe or sketch design corresponds to a unique set of DSL tokens, which serve as an intermediary language between the sketch and the final application program code. In essence, these DSL entries form the bridge that translates wireframe sketches and sketch designs into fully functional application programs.

A compiler is used to translate the DSL tokens into code, such as Python. When executed by a processor, the code enables users to create an interactive application program.

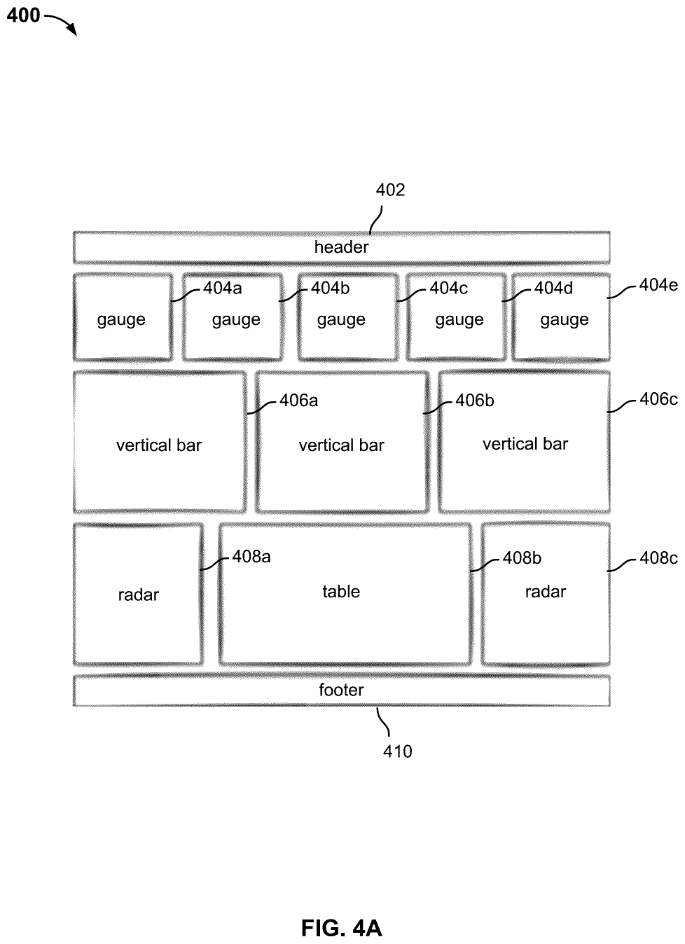

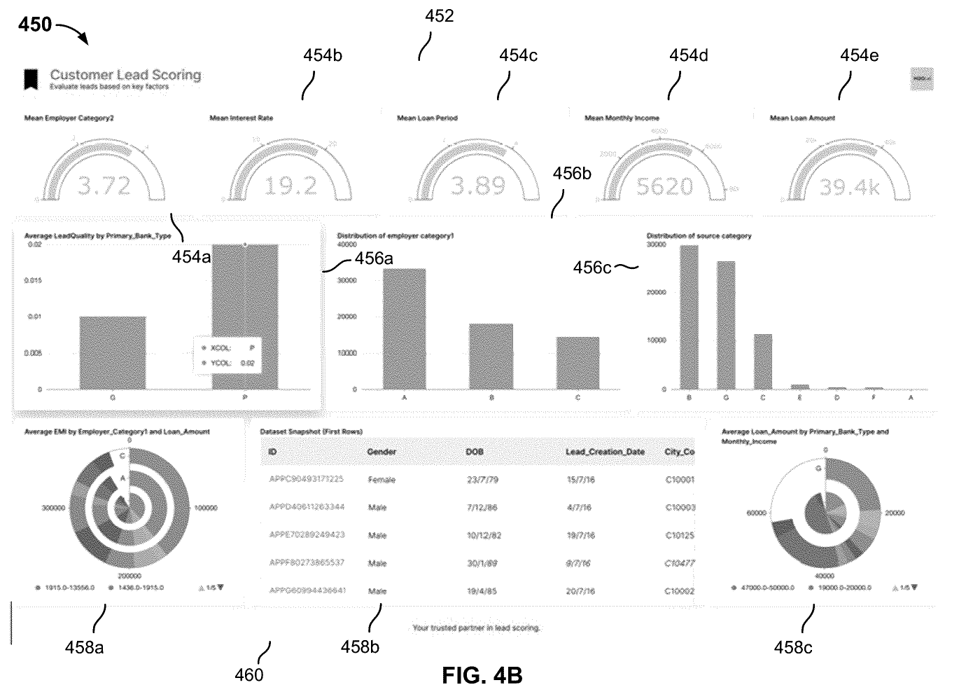

FIG. 4A is a block diagram illustrating an example of an input in accordance with some embodiments. In the example shown, input 400 includes a plurality of rows of shapes that depict what a user interface of an application program should look like. A first row of input 400 includes box 402. A second row of input 400 includes boxes 404a, 404b, 404c, 404d, 404c. A third row of input 400 includes boxes 406a, 406b, 406c. A fourth row of input 400 includes box 408a, 408b, 408c. A fifth row of input 400 includes box 410. Although input 400 includes a plurality of boxes, input 400 may include other shapes, such as triangles, circles, pentagons, etc.

The boxes may include textual information that indicates a type of UI component that should be placed at that location of the UI. Input 400 indicates that box 402 should be a header UI component, boxes 404a, 404b, 404c, 404d, 404e should be a gauge UI component, boxes 406a, 406b, 406c should be a vertical bar UI component, boxes 408a, 408c should be a radar UI component, box 408b should be a table UI component, and box 410 should be a footer UI component.

FIG. 4B is an example of an application program generated based on an input in accordance with some embodiments. In the example shown, application program 450 is generated based on an input, such as input 400, by an application program system, such as application program system 112.

Application program 450 includes UI components 452, 454a, 454b, 454c, 454d, 454e, 456a, 456b, 456c, 458a, 458b, 458c, 460. UI components 452, 454a, 454b, 454c, 454d, 454c, 456a, 456b, 456c, 458a, 458b, 458c, 460 correspond to boxes 402, 404b, 404c, 404d, 404c, 406a, 406b, 406c, 408a, 408b, 408c, 410 of input 400, respectfully. The application program system is generated application program 450 based on input 400 utilizing the techniques disclosed herein.

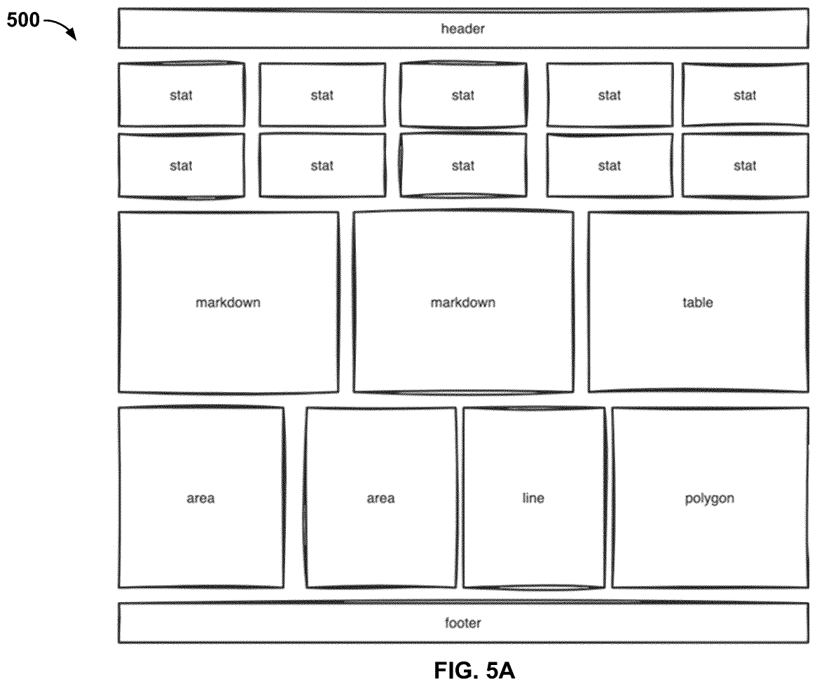

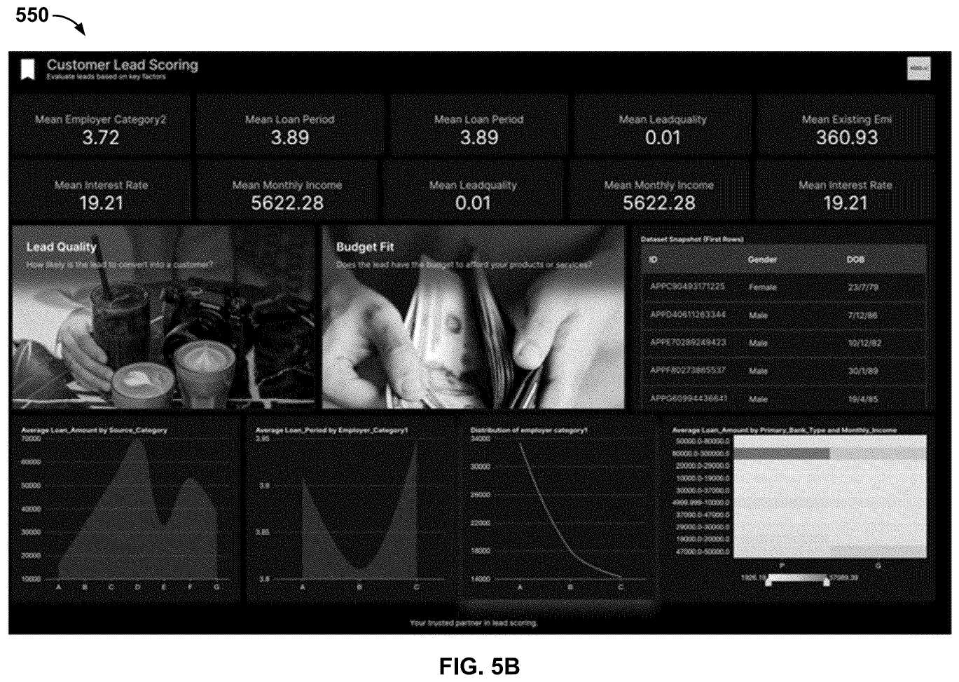

FIG. 5A is a block diagram illustrating an example of an input in accordance with some embodiments. In the example shown, input 500 includes a plurality of rows having one or more boxes included in a row. FIG. 5B is an example of an application program generated based on an input in accordance with some embodiments. In the example shown, application program 550 is generated based on input 500 by application program generation system 112.

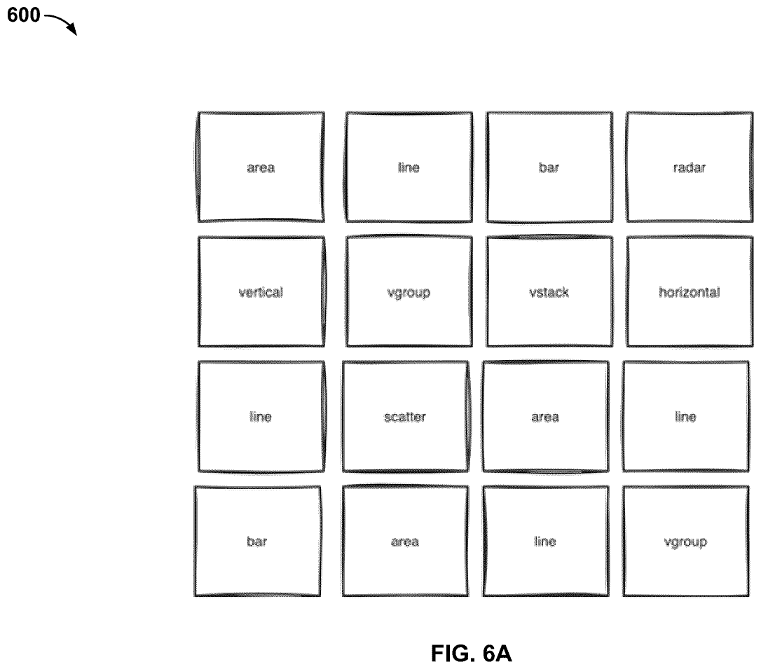

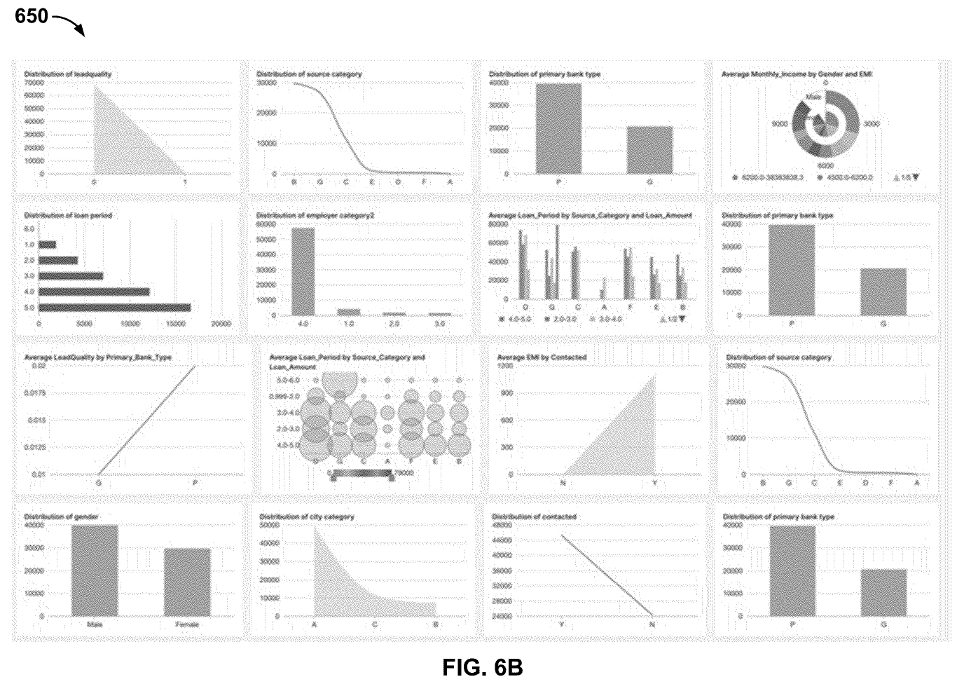

FIG. 6A is a block diagram illustrating an example of an input in accordance with some embodiments. In the example shown, input 600 includes a plurality of rows having a plurality of boxes included in a row. FIG. 6B is an example of an application program generated based on an input in accordance with some embodiments. In the example shown, application program 650 is generated based on input 600 by application program generation system 112.

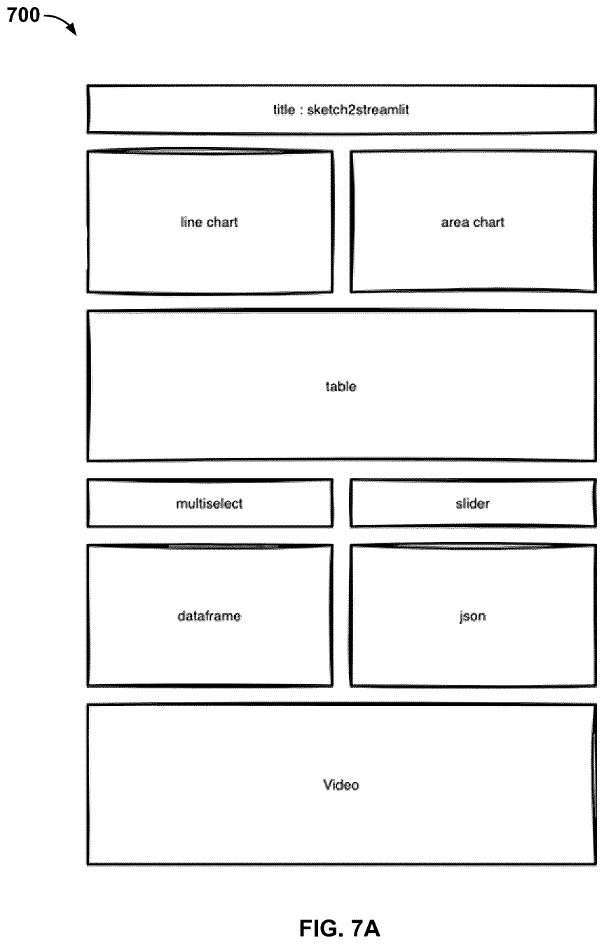

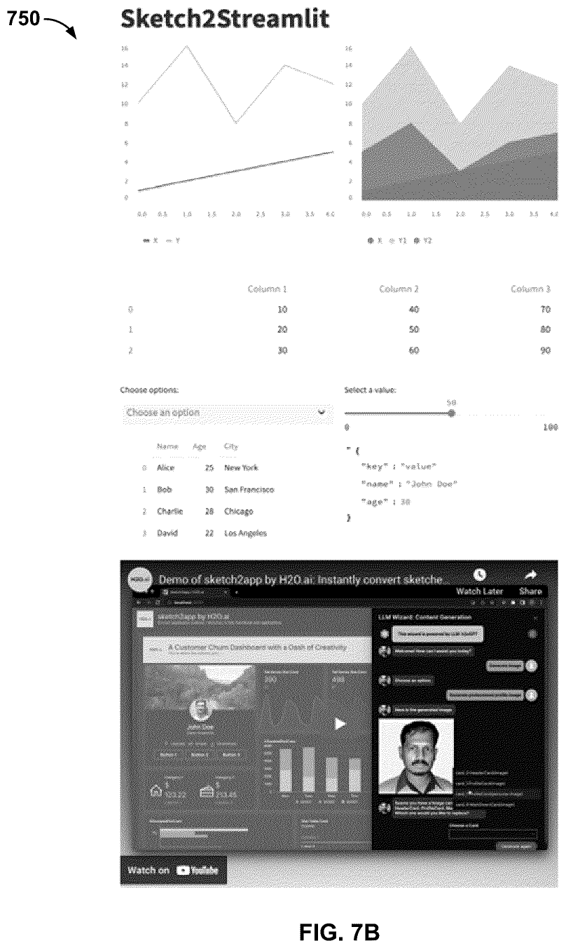

FIG. 7A is a block diagram illustrating an example of an input in accordance with some embodiments. In the example shown, input 700 includes a plurality of rows having one or more boxes included in a row. FIG. 7B is an example of an application program generated based on an input in accordance with some embodiments. In the example shown, application program 750 is generated based on input 700 by application program system 112.

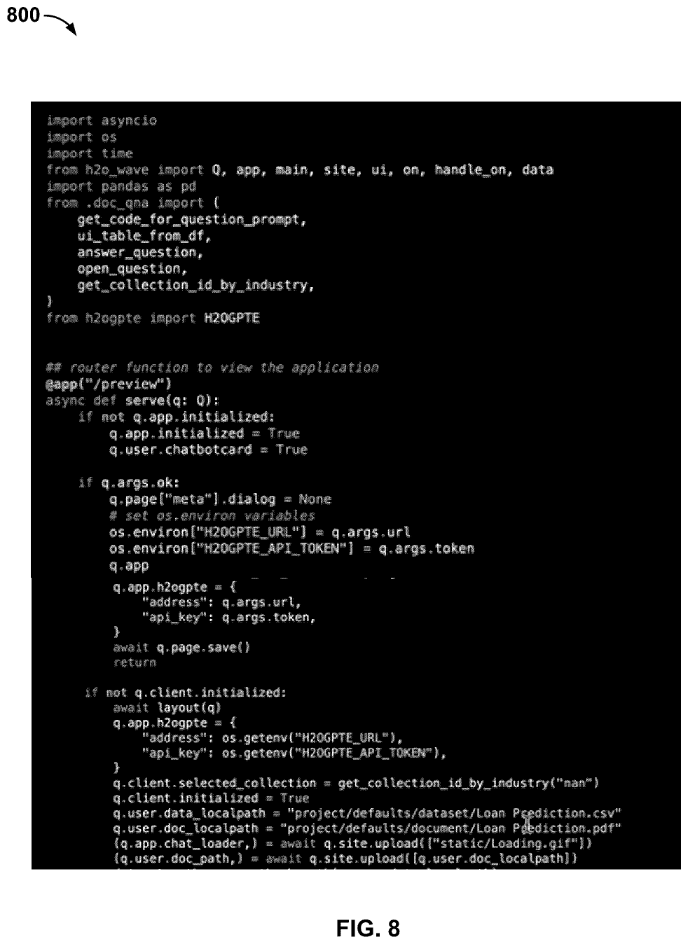

FIG. 8 is an example of source code generated for an application program in accordance with some embodiments. In the example shown, source code 800 was generated by a compiler, such as compiler 222.

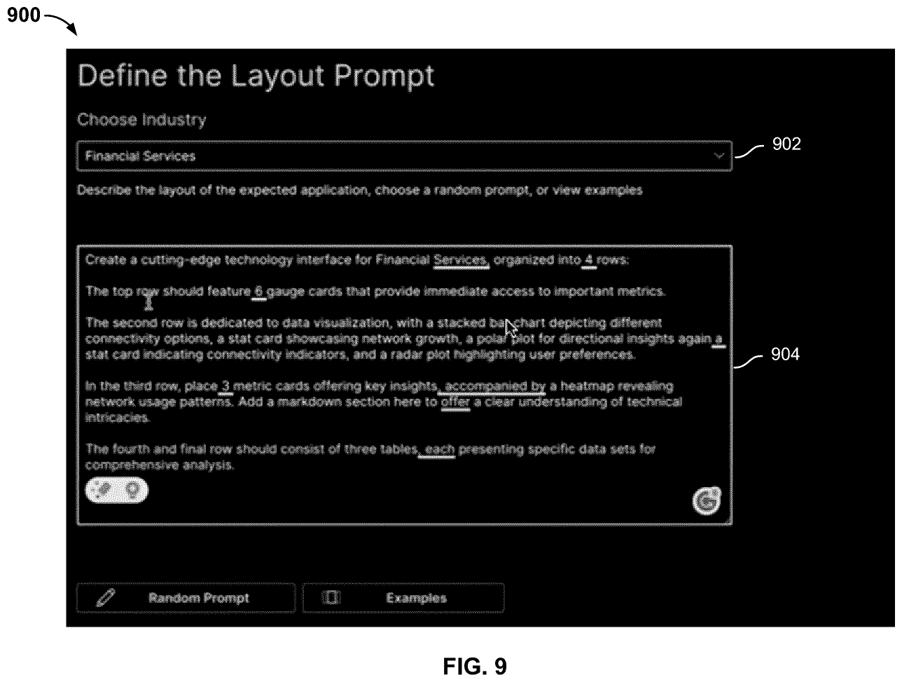

FIG. 9 is an example of an input in accordance with some embodiments. In the example shown, input 900 includes UI component 902 and UI component 904. UI component 902 is a drop down menu that allows a user to specify an industry for which the application program is to be generated. The application program may be generated for a plurality of different industries, such as predictive maintenance, agriculture, construction, consumer goods, education, energy, financial services, food and beverage, healthcare, information technology, insurance, manufacturing, media, pharmaceuticals, retail, telecommunications, etc. The appearance of the application program may differ based on the selected industry, that is, given the same prompt, the application program for a first industry may have a different appearance than the application program for a second industry. UI component 904 allows a user to specify an input prompt that describes how the application program is to look.

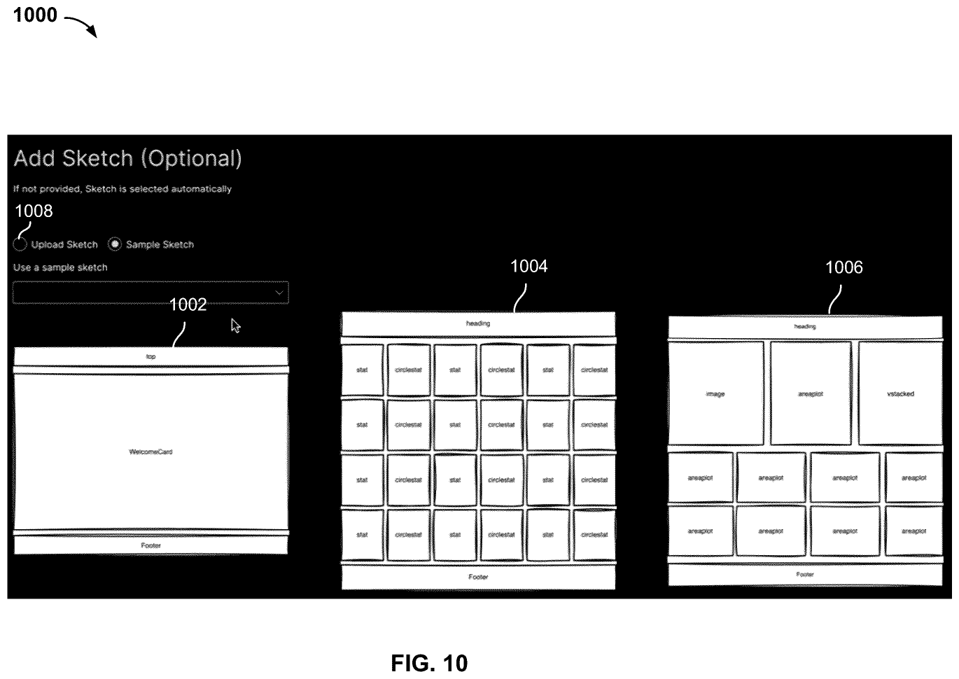

FIG. 10 is an example of a user interface from which an input is selected in accordance with some embodiments. In the example shown, UI 1000 includes a first option of a sketch design 1002 for an application program, a second option of a sketch design 1004 for the application program, and a third option of a sketch design 1006 for the application program. Although FIG. 10 illustrates three options, a user may select an input from n options of sketch designs. In some embodiments, a user selects, via UI 1000, a sketch design from a sample of sketch designs. In some embodiments, a user uploads 1008, via UI 1000, a sketch design for the application program.

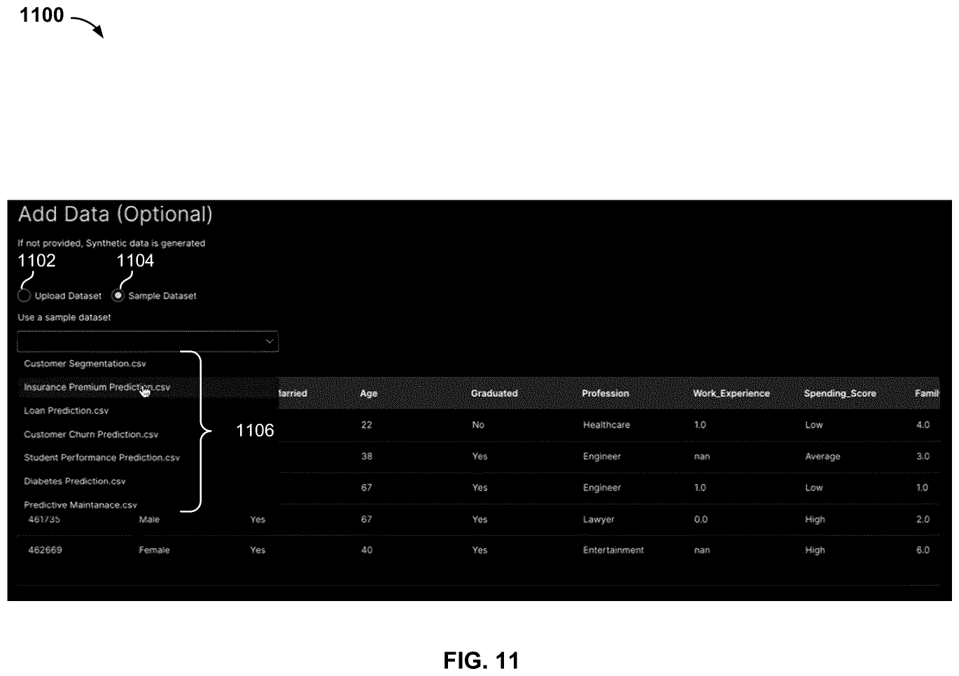

FIG. 11 is an example of a graphical user interface in which an input is provided in accordance with some embodiments. In the example shown, UI 1100 provides a user with the option to generate an application program based on an input dataset. In some embodiments, the input dataset is an uploaded dataset 1102 that includes data uploaded by the user (e.g., csv file). In some embodiments, the input data set is a sample dataset 1104 that includes sample data for a particular industry. A user may select a sample dataset 1104 from a plurality of sample datasets. There may be a sample dataset for a plurality of different industries, such as predictive maintenance, agriculture, construction, consumer goods, education, energy, financial services, food and beverage, healthcare, information technology, insurance, manufacturing, media, pharmaceuticals, retail, telecommunications, etc.

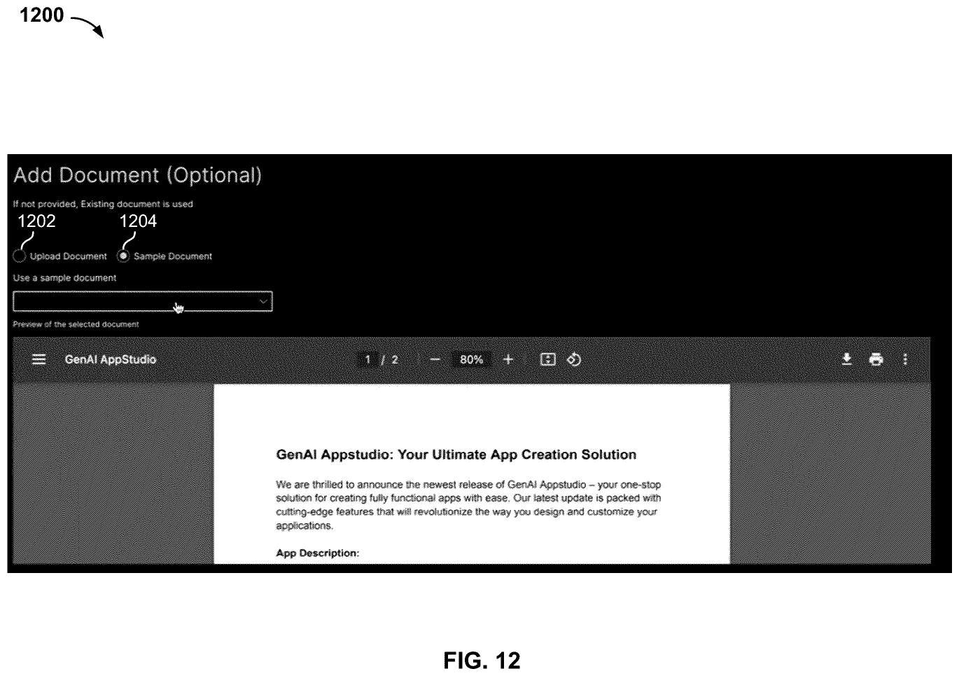

FIG. 12 is an example of a user interface in which an input is provided in accordance with some embodiments. In the example shown, UI 1200 provides a user with the option to generate an application program based on a document. In some embodiments, the input is an uploaded document 1202 that describes the application program to be generated (e.g., text file, word document, etc.). In some embodiments, the input is a sample document 1204 that describes the application program to be generated. The sample document 1204 may describe the application program to be generated for a particular industry. A user may select a sample document 1204 from a plurality of sample documents. There may be a sample documents for a plurality of different industries, such as predictive maintenance, agriculture, construction, consumer goods, education, energy, financial services, food and beverage, healthcare, information technology, insurance, manufacturing, media, pharmaceuticals, retail, telecommunications, etc.

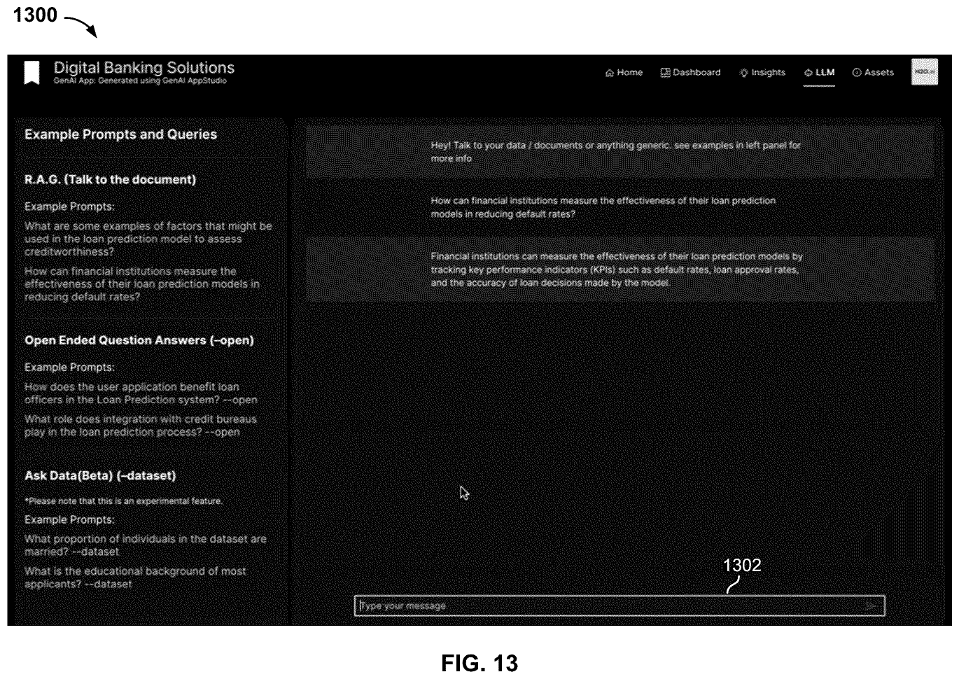

FIG. 13 is an example of a user interface in which a large language model is used to generate insights into the data associated with an application program. In the example shown, UI 1300 provides a user with the option to perform a query 1302. The application program may utilize a LLM to generate insights based on the query 1302. The insights may include statistical views, continuous variables, histograms, mean, median, modes, etc.

Although the foregoing embodiments have been described in some detail for purposes of clarity of understanding, the invention is not limited to the details provided. There are many alternative ways of implementing the invention. The disclosed embodiments are illustrative and not restrictive.

1. A method, comprising:
receiving an input specifying a schematic of user interface components of an application program;
using a first group of one or more machine learning models to automatically identify the user interface components and associated properties specified in the input; and
based on the identified user interface components and the associated properties, using a second group of one or more machine learning models to automatically generate program code implementing the application program including the user interface components.

2. The method of claim 1, wherein the input includes an image, a prompt, a data file, or a document.

3. The method of claim 1, wherein the one or more machine learning models of the first group remove noise from the input.

4. The method of claim 1, wherein the one or more machine learning models of the first group identify in the input one or more shapes that correspond to the user interface components of the application program.

5. The method of claim 4, wherein at least one of the one or more shapes is a rectangle.

6. The method of claim 4, wherein the one or more machine learning models of the first group automatically identify the user interface components and associated properties specified in the input at least in part by:
loading the input using a computer vision library;
converting the input into a grayscale version of the input; and
applying an edge detection algorithm to identity corresponding edges of the one or more shapes and their contours.

7. The method of claim 4, wherein the one or more machine learning models of the first group automatically identify the user interface components and associated properties specified in the input at least in part by determining whether any of the one or more identified shapes include one or more nested shapes.

8. The method of claim 4, wherein the one or more machine learning models of the first group automatically identify the user interface components and associated properties specified in the input at least in part by filtering an identified shape of the one or more identified shapes.

9. The method of claim 8, wherein the identified shape is filtered based on its dimensions being below a threshold.

10. The method of claim 8, wherein the identified shape is a repetitive shape.

11. The method of claim 10, wherein the identified shape is determined to be the repetitive shape for having a center coordinate difference with another identified shape that is below a set threshold.

12. The method of claim 4, wherein the one or more machine learning models of the first group automatically identify the user interface components and associated properties specified in the input at least in part by redefining an identified shape of the one or more shapes by representing the identified shape by its center coordinates and dimensions instead of boundary coordinates associated with the identified shape.

13. The method of claim 4, wherein the one or more machine learning models of the first group automatically identify the user interface components and associated properties specified in the input at least in part by extracting textual information from the one or more identified shapes.

14. The method of claim 13, wherein the extracted textual information is utilized by the one or more machine learning models of the second group to determine a corresponding function associated with the one or more identified shapes.

15. The method of claim 4, wherein using the one or more machine learning models of the second group at least in part includes determining corresponding zones associated with the one or more identified shapes.

16. The method of claim 15, wherein using the one or more machine learning models of the second group at least in part includes generating a two-dimensional grid structure that organizes the one or more identified shapes based on the determined corresponding zones associated with the one or more identified shapes.

17. The method of claim 16, wherein using the one or more machine learning models of the second group at least in part includes generating a corresponding token for the one or more identified shapes based on an output of the one or more machine learning models of the first group and the two-dimensional grid structure.

18. The method of claim 17, wherein the corresponding generated token for the one or more identified shapes is specified to a particular domain structured language.

19. The method of claim 18, wherein the program code is generated by a compiler based on the corresponding generated token for the one or more identified shapes.

20. The method of claim 1, further comprising generating the application program that includes the user interface components based on the automatically generated program code.

21. The method of claim 1, further comprising utilizing a large language model to provide one or more insights into data associated with the application program.

22. A system, comprising:
a processor configured to:
receive an input specifying a schematic of user interface components of an application program;
use a first group of one or more machine learning models to automatically identify the user interface components and associated properties specified in the input; and
based on the identified user interface components and the associated properties, use a second group of one or more machine learning models to automatically generate program code implementing the application program including the user interface components; and
a memory coupled to the processor and configured to provide the processor with instructions.

23. A computer program product embodied in a non-transitory computer readable medium and comprising computer instructions for:
receiving an input specifying a schematic of user interface components of an application program;
using a first group of one or more machine learning models to automatically identify the user interface components and associated properties specified in the input; and
based on the identified user interface components and the associated properties, using a second group of one or more machine learning models to automatically generate program code implementing the application program including the user interface components.
